(19) United States
(12) Patent Application Publication
(10) Pub. No.: US 2006/0080137 A1
(43) Pub. Date: Apr. 13, 2006

(54) USB MED STICK with personal medical history

(76) Inventors: Kevin Bond Chambers, Lakeland, FL (US); Eugene Frances Thorner, Lakeland, FL (US)

Correspondence Address: Kevin B. Chambers, 1303 Brighton Way, Lakeland, FL, 33813, US

(21) Appl. No.: 10/956,436

(22) Filed: Oct. 4, 2004

(51) Int. Cl. G06Q 50/00

(52) U.S. Cl. 705/2

(57) ABSTRACT

The invention uses the technology of the common USB (flash) drive to hold a person's medical history and can be carried on a key chain or in your pocket or purse. The medical history is entered by the owner of the USB drive and is protected by a user ID and password. The invention provides for the digital storage and retrieval of user's medical records that includes drug prescriptions, medical history, doctors, religion preference, living will, medical power of attorney and personal identification. Information can be retrieved and read by any window's base computer that has an available USB port. This invention will self boot and give you access to a medical emergency screen that shows vital information in matter of seconds without a users password all other information stays private. Data is encrypted to ensure security on the drive and a copy can be placed on the local hard drive and/or in a secure database via the internet, that can be accessed anywhere, 24/7 using your ID and password.

### BACKGROUND OF THE INVENTION

1. Field of Invention

This invention relates to Medical History, specifically to provide personal Medical information.

2. Objects and Advantages

Accordingly, several objects and advantages of the inventions are: Correct Medical History when you need it, fast convenient way to access it, easy to carry, Inexpensive and easy to replace. Further objects and advantages will become Apparent from a consideration of the ensuing description and drawings.

### SUMMARY

My Med Stick is a device to provide total medical conditions and history at the critical Time of need. This includes all applications like Doctor visits, hospital stays, or Emergency care.

### DRAWING FIGURES

FIG. 1—Software flowchart

FIG. 2—Process Chart

FIG. 3—Members Info screen

FIG. 4—Contacts screen

FIG. 5—Primary Care Physician

FIG. 6—Religious preferences

FIG. 7—Health Insurance

FIG. 8—Living Will for Coma Victims

FIG. 9—Living Will for Terminal Illness

FIG. 10—Living Will for Non-Terminal

FIG. 11—Allergies and Medications: Allergies to food, Plants, and Medical Conditions

FIG. 12—Medications: Medications currently on.

FIG. 13—Ophthalmologic

FIG. 14—Medical Disclaimer and Release

### DRAWING FIGURES DEFINED

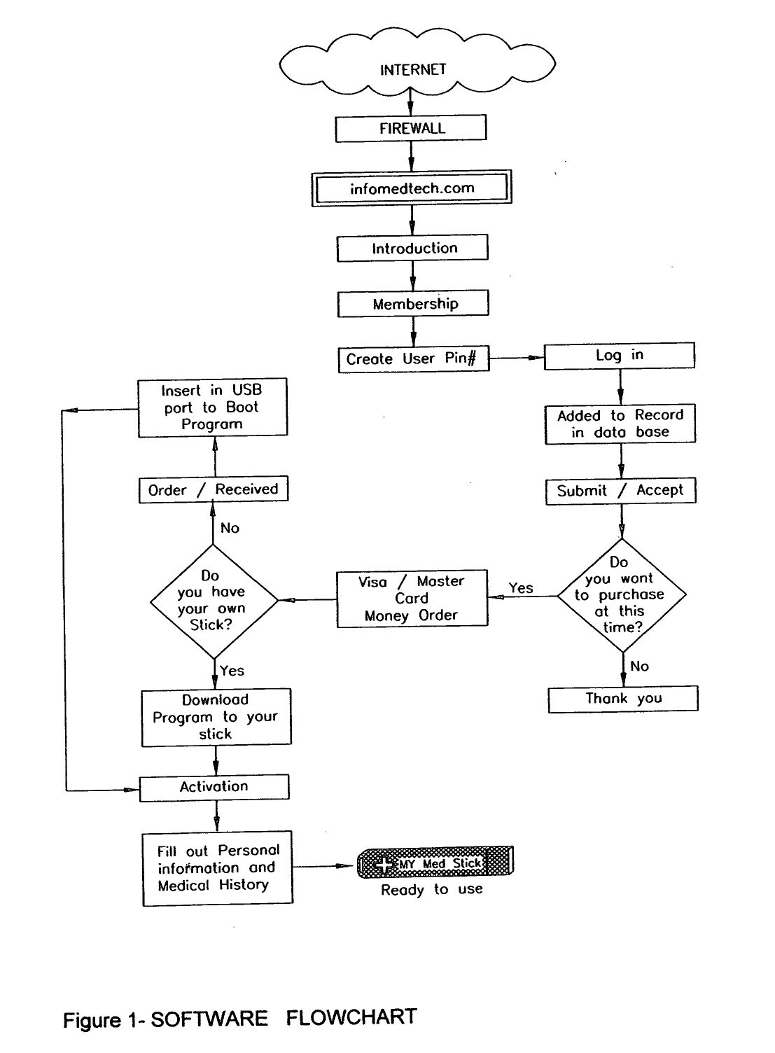

FIG. 1—Demonstrates connection through the Internet to the website where a person can become a member and create a user pin number. Once logged in they can add their name to the membership. If they accept our terms they will be asked to purchase at this time. If the answer is yes they can pay by credit card.

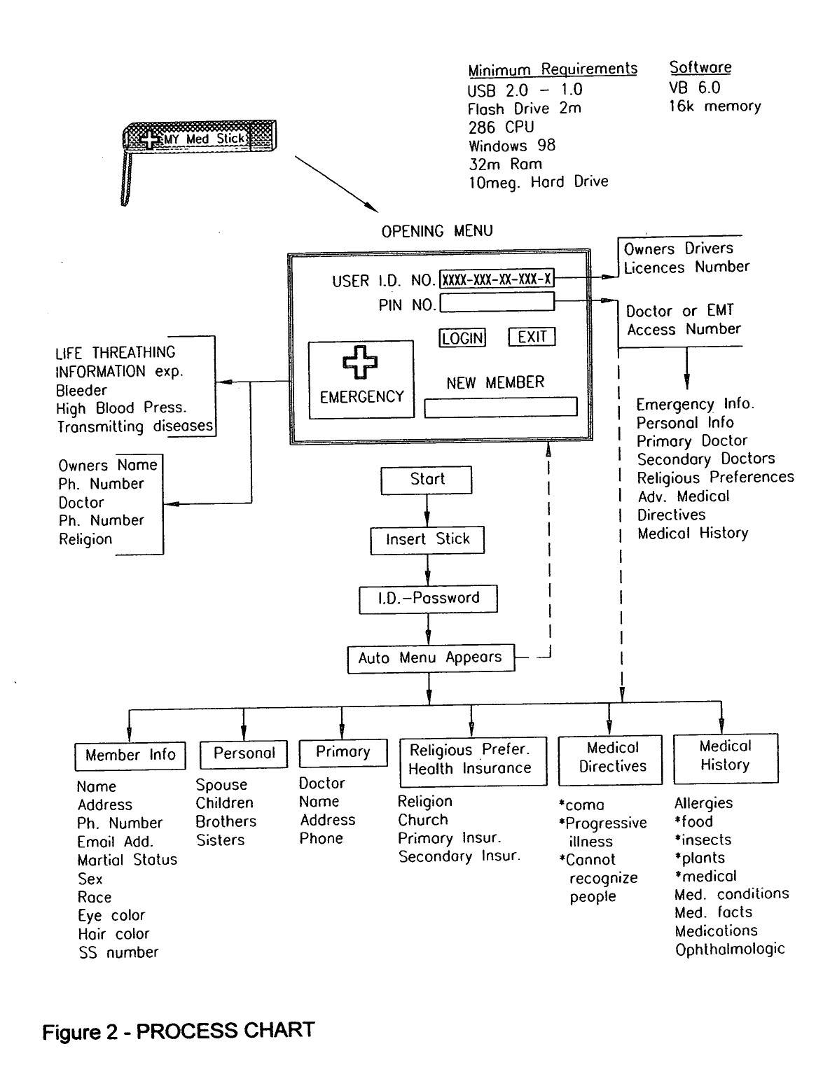

FIG. 2—shows medium requirements for hardware. The opening menu is shown and Describes how to fill out each part of the form.

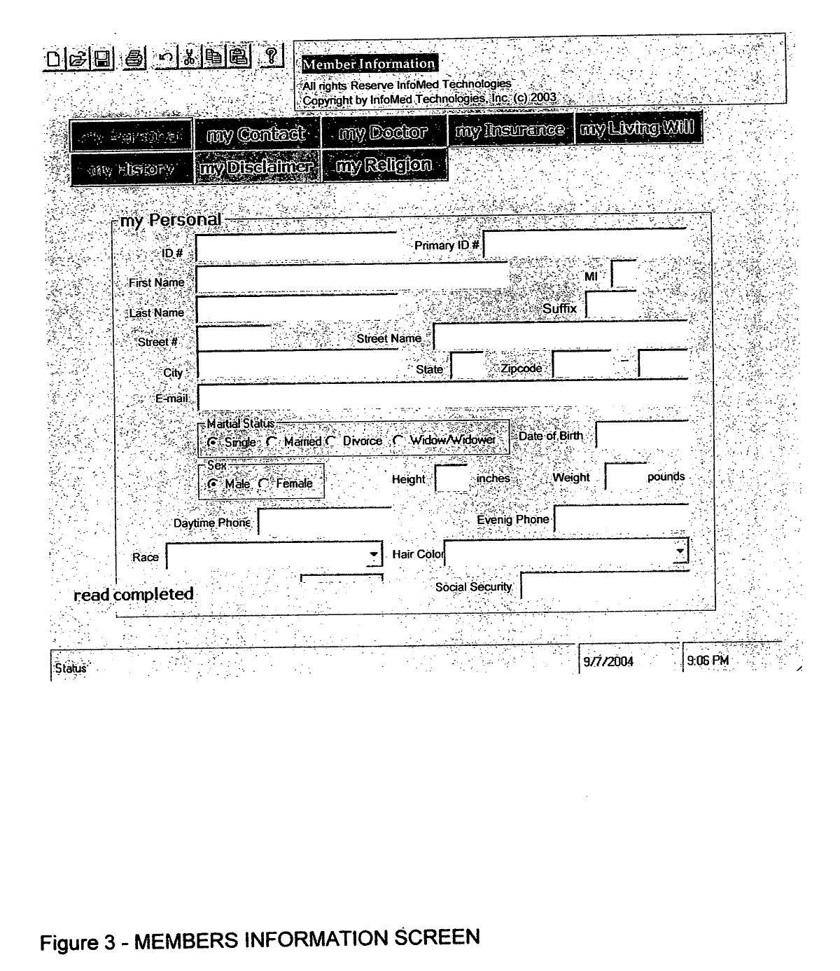

FIG. 3—is a print screen of the Members personal information

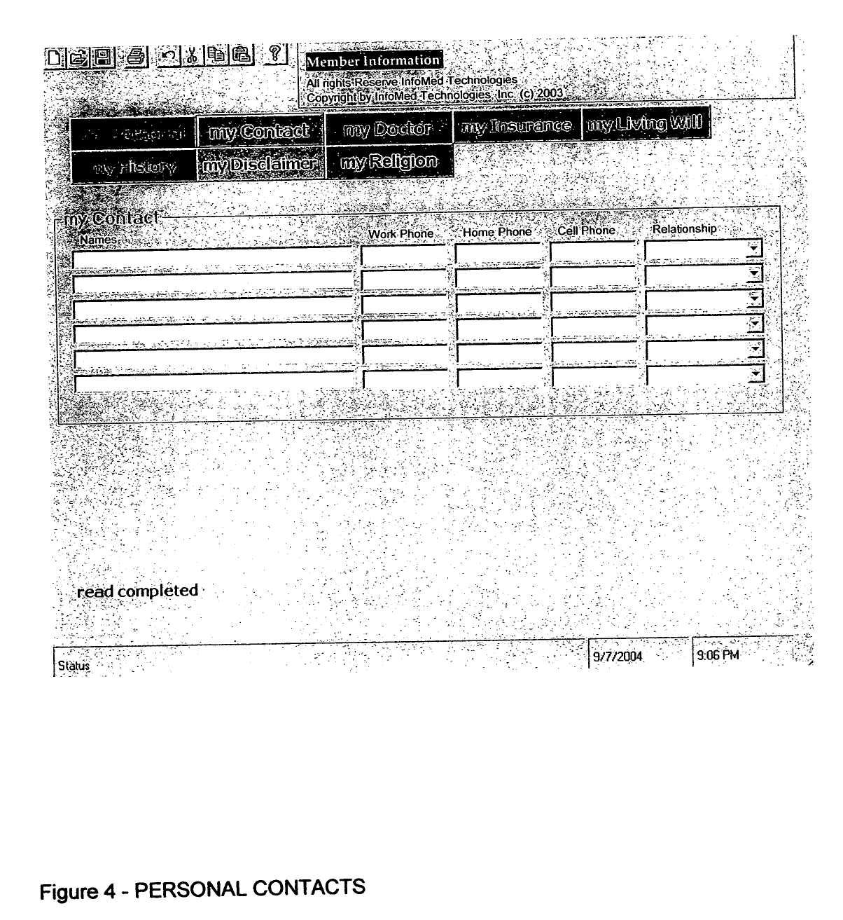

FIG. 4—shows the PERSONAL contacts in case of emergency

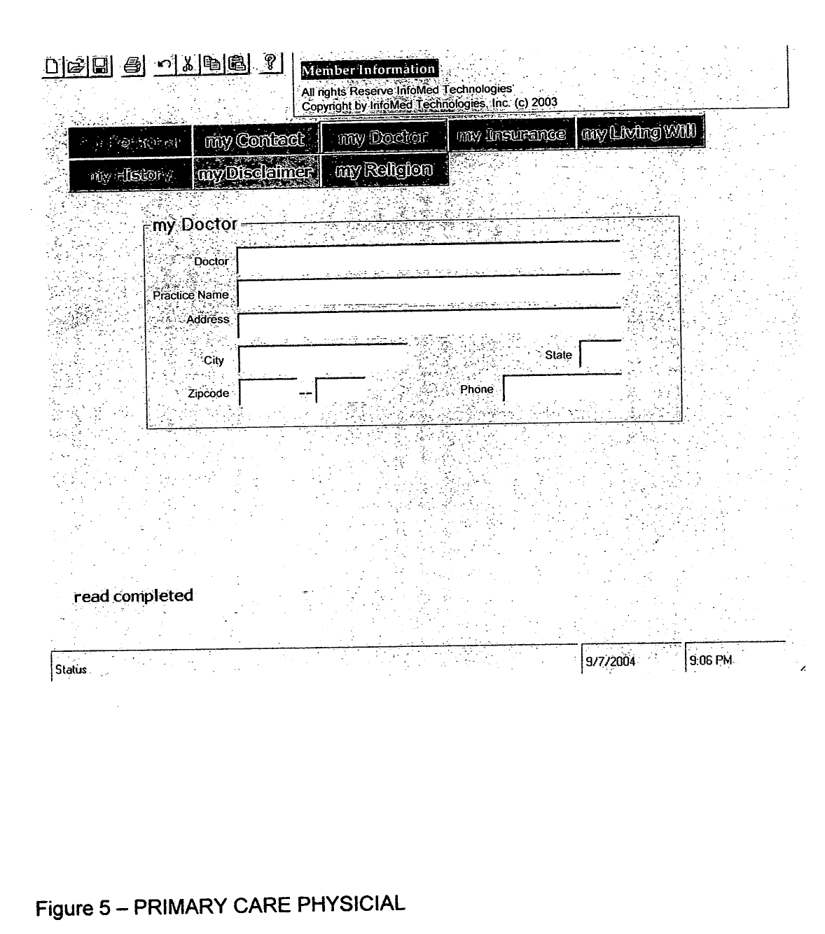

FIG. 5—shows the screen to fill out information on the PRIMARY CARE PHYSICIAN

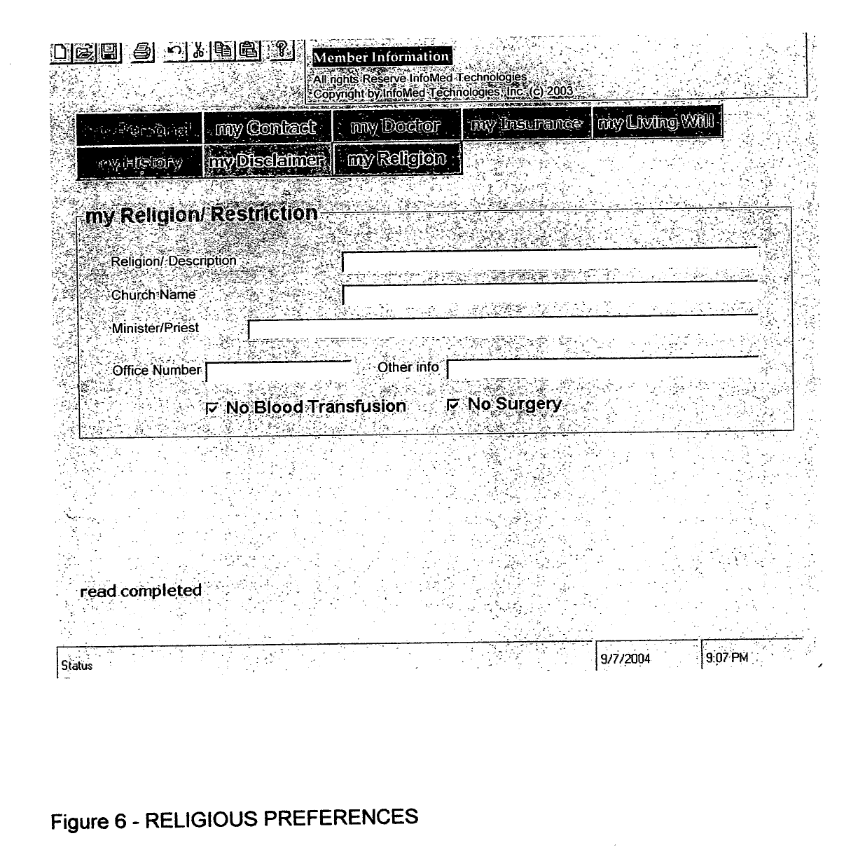

FIG. 6—shows RELIGIOUS PREFERENCE and descriptions, contact information

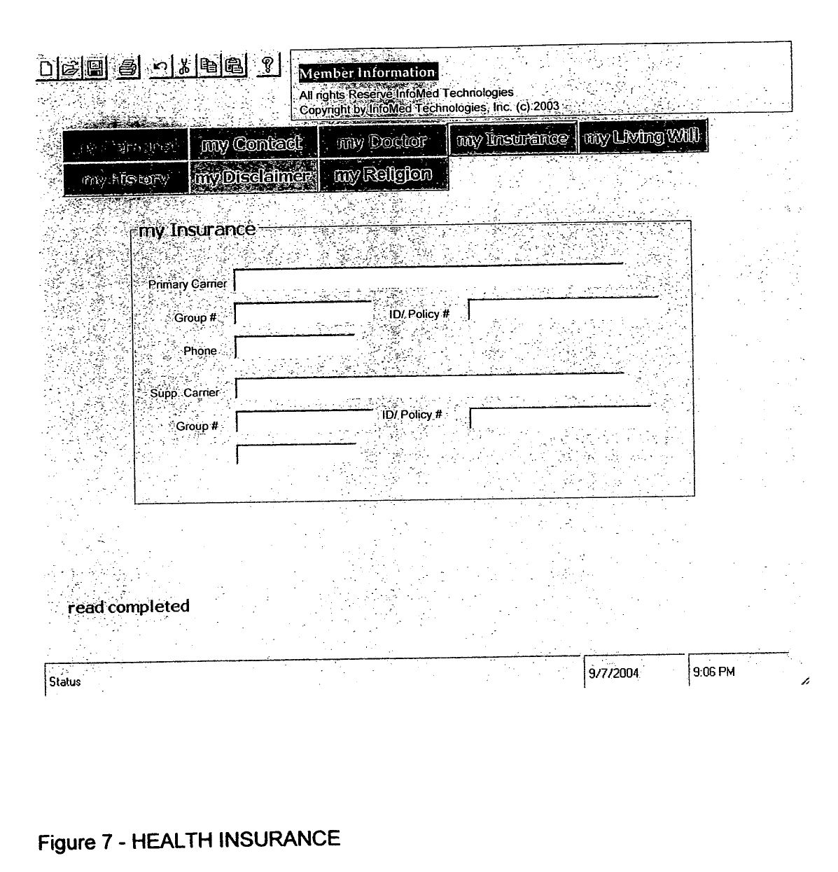

FIG. 7—Print screen of HEALTH INSURANCE for primary and secondary carrier

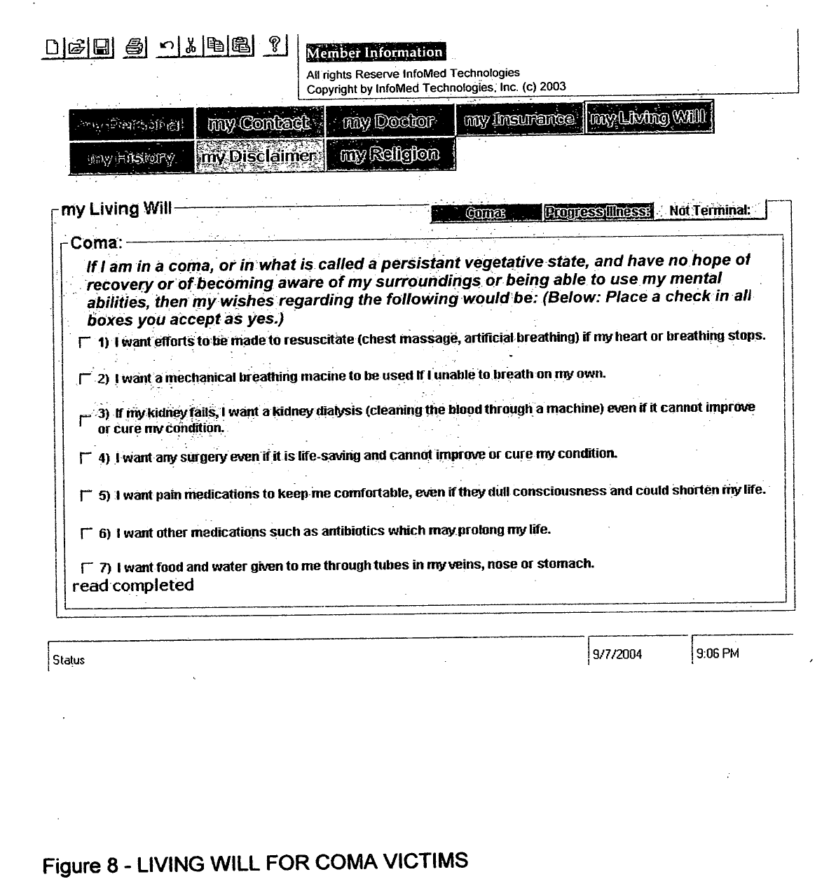

FIG. 8—Shows medical directive for Living Will in case of a COMMA situation

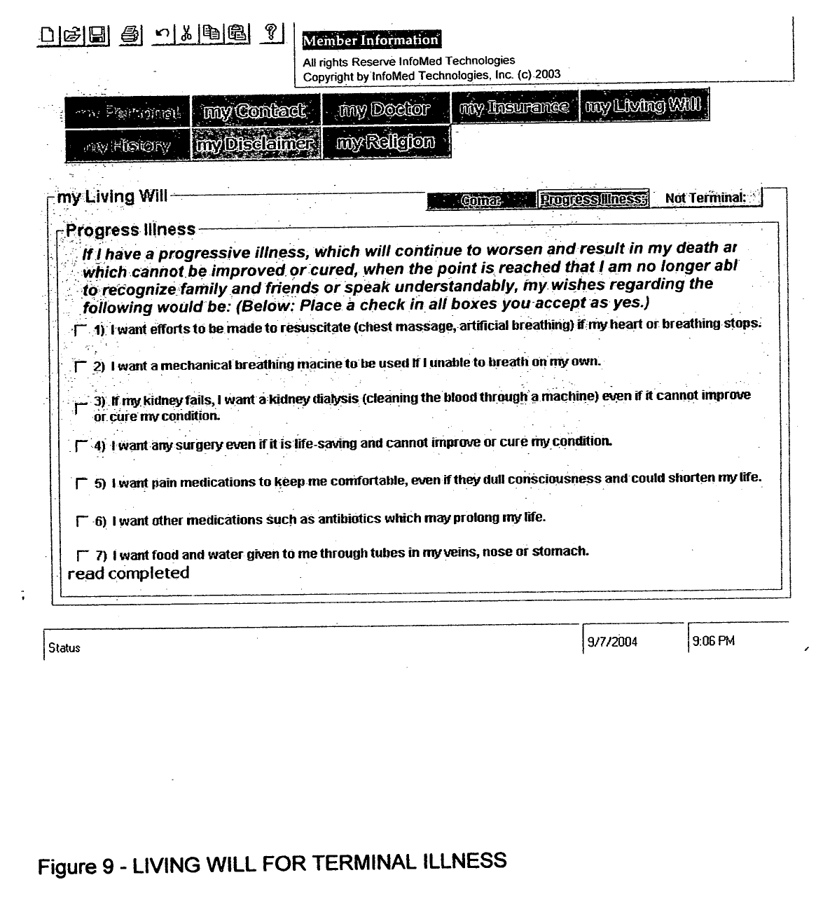

FIG. 9—Shows the Living Will of a person with a TERMINAL illness. Check the box or the Corresponding illness

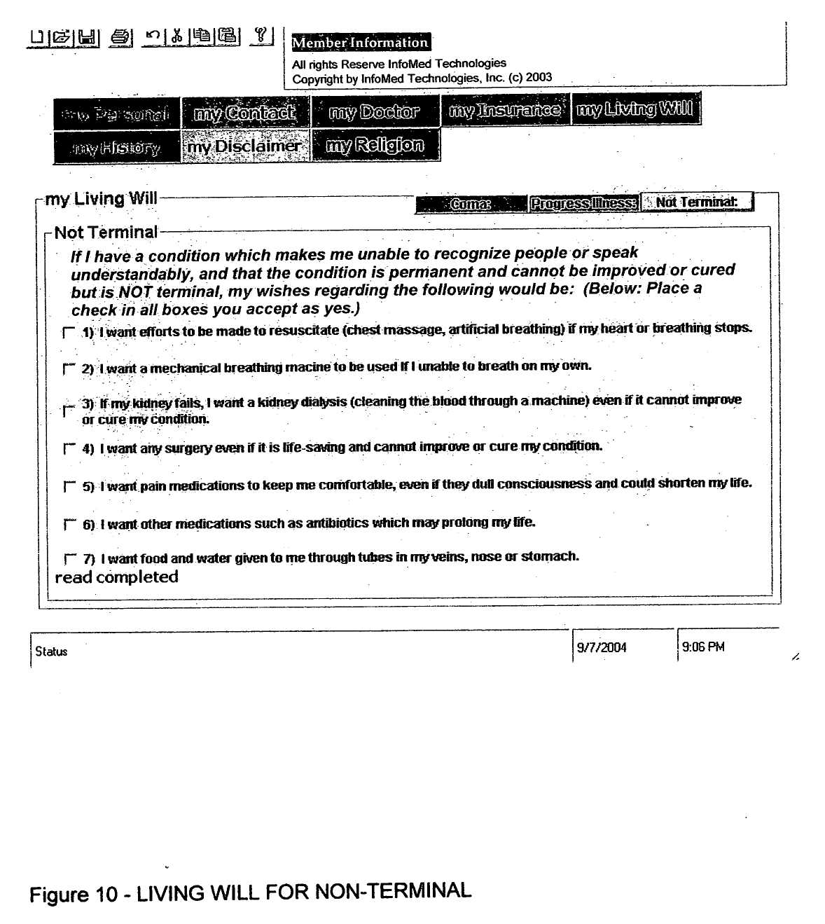

FIG. 10—Is the medical directive of a NON-TERMINAL illness.

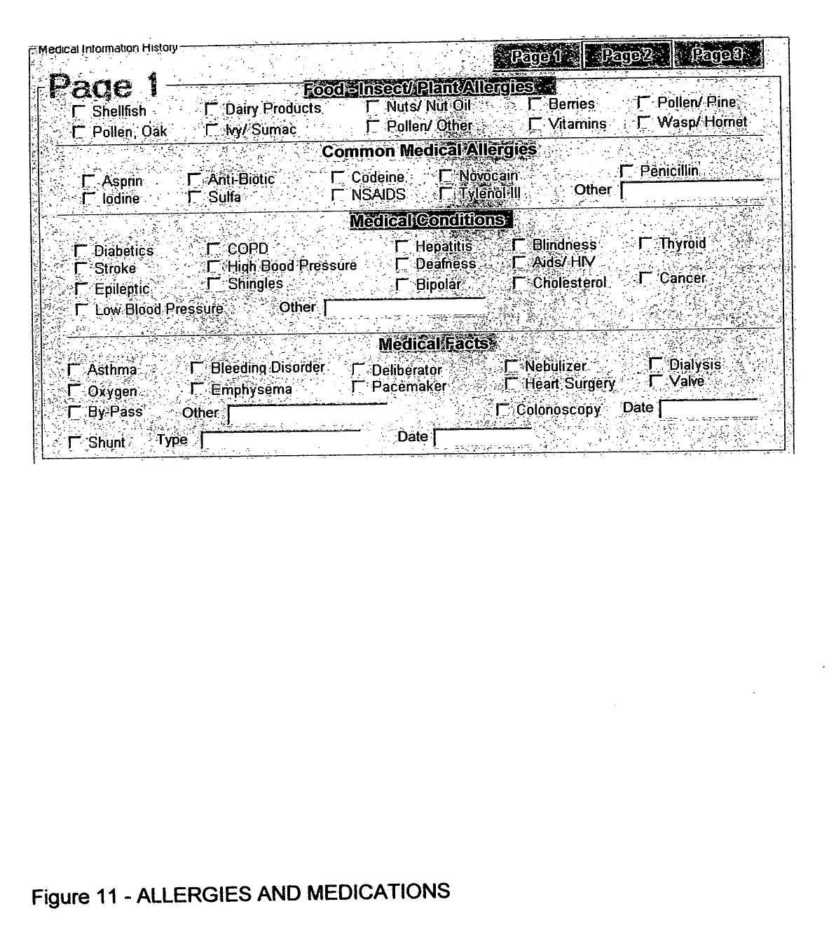

FIG. 11—Check each box that indicates a problem with ALLERGIES to food, plants, and Medical conditions.

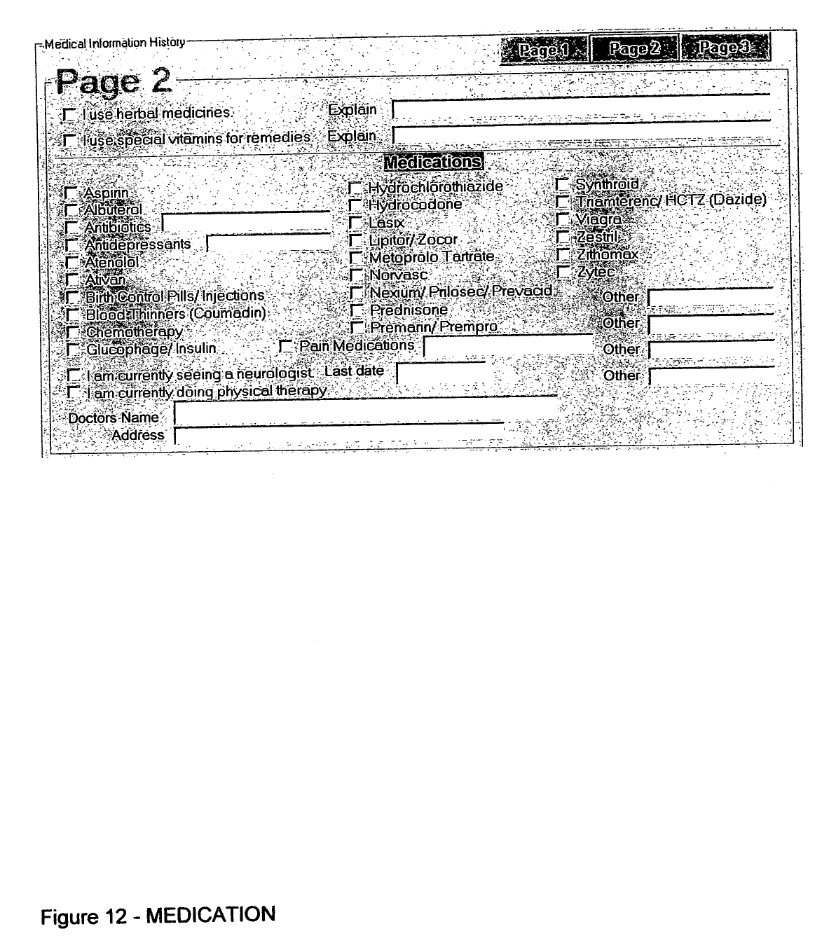

FIG. 12—Check each box for MEDICATIONS currently on or fill in OTHER

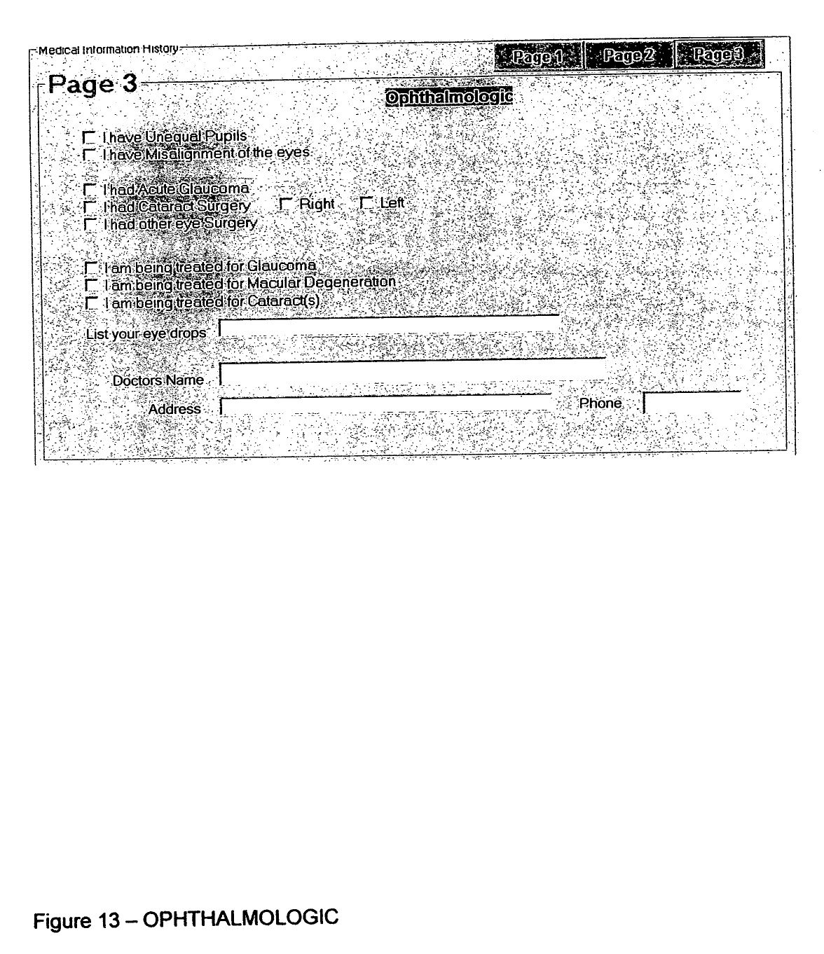

FIG. 13—Check each box for Assisted Devices or fill in OTHERS

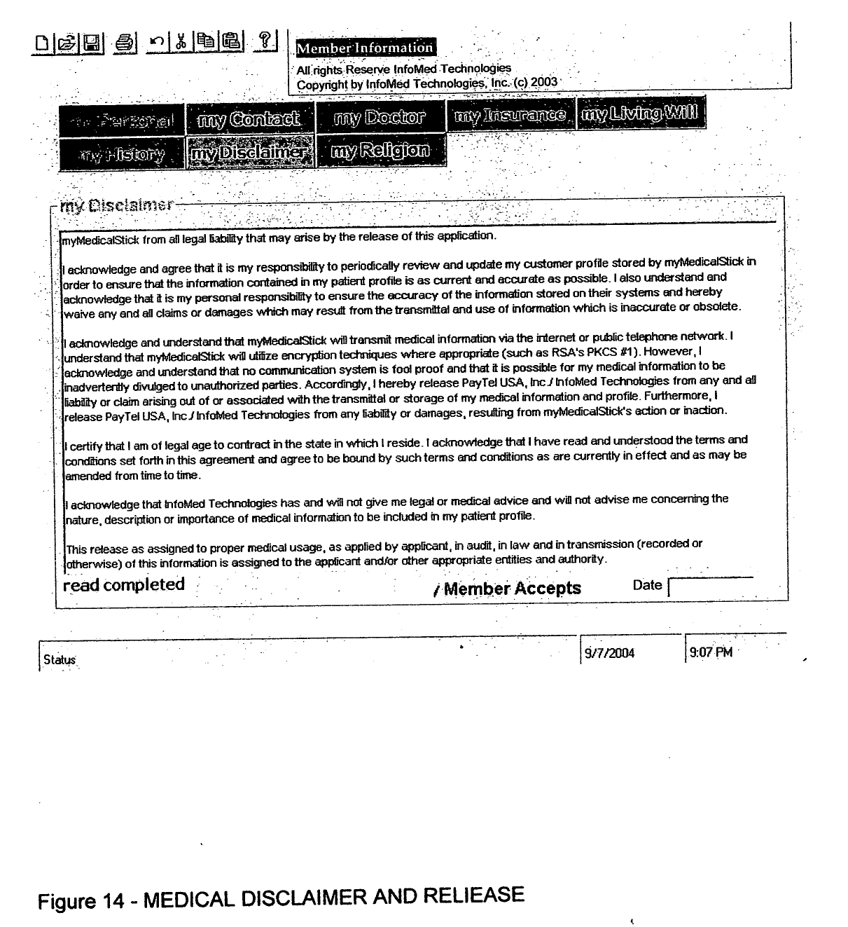

FIG. 14—States MEDICAL DISCLAIMER and release statement, members over 18 must Accept and date.

### CONCLUSION, RAMIFICATIONS, AND SCOPE

When you go to the Doctor's office or in the hospital, this MED STICK will hold all your medical information. In the near future, you will have all the correct medical information that you need when it is needed. Filling out the bothersome medical forms will be in the past. In an emergency you could be unconscious and be allergic to a medicine that they would normally give you in that situation. This would alleviate that possibility.

The MED STICK holds all the information inside a chip. The chip is encrypted and can only be accessed by an authorized person. The information is also stored in a database that can be accessed by the MED STICK holder or a facility that has permission to read it. The only person that can change the data is the owner of the MED STICK by way of his own personal ID and Password.

Hundreds of people everyday make mistakes entering medical information to hospitals and insurance companies, usually because you are in a place where you can't get to the information you need. By putting the data on a MED STICK before you get to the Dr's. Office or hospital would eliminate errors that might cause insurance companies to deny your claim.

A few places you would use the MED STICK are as follows.
Dr.'s office visit
Ambulance or EMT
Rescue Firefighters
Hospital
Police
Medical Clinics

A MED STICK will definitely come in handy when you're away from home and do not know your medications or allergies also when you Leave your child with someone and an accident occurs, or your in a accident or sick and unable to speak or communicate with the EMT.

We always need to be able to identify minor children and seniors and their special needs such as a medical alert. i.e. Pacemaker, stents, or just to help them to return to their home or family if they are lost.

It would be helpful in protecting your family, using the MED STICK, by eliminating mistakes that can happen in critical situations. It could save your life or the life of your loved one.

Thousands of people each year are hurt or even die, just because no one knew of your personal Medical information in time.

You can obtain the MED STICK by two methods (1) Visit our web site to download the program if you have your own USB drive or (2) order by filling out the (on-screen) form at our website for each application. You can purchase the MED STICK using your credit or check card or by money order. After your medical information is added to the stick, you are now ready to put the MED STICK in your pocket, purse or added to a key chain or leave it with the person caring for your child.

The MED STICK holder can regularly update the MED STICK via Internet to assure he has the latest information.

This invention solves the problem of you not having your complete Medical history Including complex medicines, illness history dates and other pertinent information at the time of an accident, medical emergency or just visiting your Doctor for the first time. Other advantages such as funeral arrangements, final expenses, last will and testament, veterinarian info. dentist info, power of attorney, estate planning, family tree. Photo ID of member can be added at your convenience. MED STICK can also be used to import your health info. into other customized programs.

If for is some reason the MED STICK can't be read, the Doctor, Hospital or EMT can call a 800 number located on the stick to get your medical information.

1. My medical stick will provide important information about your medications, allergies, medical assisted devices, prostheses, or personal contacts in case of an emergency: Parents or guardians that are watching your children will find the MED STICK invaluable. Pre-authorization can be included on the Stick giving the medical facility permission to save that child's life without wasting precious time calling for authorization. People with medication allergies will find this very valuable, especially in an emergency situation. With medical directives already on the Stick, there is little room for error and it could save their life or, in case of death, give legal directives to hospital or next of kin. The ER or EMT will be able to see your medical records in a FLASH. A computer or laptop with USB input can read the information, because everything is contained in the Stick. No need for a special reader or program on the computer. Just put the Stick in the USB ports and up comes the welcome screen. If this is an emergency, then just hit the (on-screen) “RED” emergency button and only the information necessary to save your life will appear. This system is easy as 1-2-3: FIRST, purchase the Stick from the sales rep or online at our website: SECOND, put the stick in a computer and click, “add new member”, acquire a registration number, then fill out the on screen form to the best of your ability. Information can be updated or added at a later date. THIRD, test the unit using the test button and that's it. You are now prepared for that accident and medical emergency. MY MEDICAL STICK can be kept in your purse or wallet, or put it on a necklace or key chain. Easy to read instructions comes with each Stick to help you through the process of completing the fields and saving the information. MY MEDICAL STICK is so easy to use that very little computer skills are necessary.
